(19) United States
(12) Patent Application Publication
(10) Pub. No.: US 2025/0034434 A1
(43) Pub. Date: Jan. 30, 2025

(54) VISUALLY ENCODED FOIL TAPE ROLL FOR GLASS FOILING

(71) Applicant: Michael Hacikyan, Naples, FL (US)

(72) Inventor: Michael Hacikyan, Naples, FL (US)

(21) Appl. No.: 18/359,680

(22) Filed: Jul. 26, 2023

(51) Int. Cl. C09J 7/28; B65H 35/00

(52) U.S. Cl. CPC C09J 7/28; B65H 35/002; B65H 2701/173; B65H 2701/377; C03C 27/08; C03C 2217/253; G01B 2003/1097

(57) ABSTRACT

A visually encoded foil tape roll for glass foiling includes a tape roll core with flexible metallic foil tape wound thereon. The foil tape includes a metal foil layer, an adhesive layer on one side of the metal foil layer, and a peelable adhesive backing layer on the adhesive layer. The foil tape has a width dimension corresponding to an edge thickness of a glass edge onto which the foil tape is to be applied. The tape roll core displays a non-alphanumeric visual encoding selected to identify the width dimension of the foil tape and distinguish the foil tape roll from other foil tape rolls that comprise foil tape having different width dimensions and tape roll cores of different non-alphanumeric visual encodings. The foil tape roll may be dispensed from a foil tape dispenser having a detachable dispensing tip displaying a non-alphanumeric visual encoding matching the tape roll visual encoding.

### BACKGROUND

### 1. Field

The present invention relates generally to glass foiling. More particularly, the invention concerns foil tape rolls used for foiling glass edges in the fabrication of glass artwork and decorative glass products.

### 2. Description of the Prior Art

By way of background, glass foiling is a process in which a length of metallic foil tape is applied around the edges of a piece of glass so that the glass piece can be soldered to other glass pieces in order to fabricate glass artwork or decorative glass products. The foil tape, which is typically copper, has adhesive on one side for adhering the foil to the glass. The foil tape is typically wrapped around a plastic core to form a foil tape roll. The core is typically about 3 inches (76 mm) in diameter, and the fully wound roll diameter is typically about 4-5 inches (102-127 mm) in diameter. To prevent the adhesive from adhering to adjacent windings of the roll, a peelable non-adhesive backing is applied over the adhesive.

In order to facilitate effective soldering, the foil tape should be wider than the thickness of the glass, such that longitudinal side sections of the tape overhang each side of the glass edge. As shown in FIG. 1A, the sides sections of the foil tape that overhang the glass edge are crimped and adhered to each face of the glass piece to form a double-crimped U-shaped foil covering. As shown in FIG. 2A, the glass piece may then be maneuvered into adjacent relationship with one or more other glass pieces that are similarly foiled and ready to be assembled. This operation is typically performed with the glass pieces arranged on a table or other flat surface. As shown in FIGS. 1B and 2B, the foiled edges of the adjacent glass pieces may then be butted up against each other, such that the foil tape side sections on the exposed face of each glass piece are contiguous at each point where the foiled edges meet. As shown in FIGS. 1C and 2C, solder joints may be formed by applying beads of solder along the contiguous foil tape side sections so as to bond them together, thus forming a glass assembly. The soldering operation is first performed on one side of the glass assembly, and the assembly is then flipped over so that the soldering process can be repeated on the opposite side of the assembly.

The proper foil tape width for a given piece of glass is one that provides enough foil tape to completely cover the glass edge and also wrap around onto each face of the glass by an amount that provides enough surface area to form an adequate solder joint. The amount by which the foil tape wraps around onto the faces of the glass can be varied according to how much solder is to be applied, with a minimum side-wrap distance of 1/32 inches (0.8 mm) being quite common. This provides enough foil tape width to form a 1/16 inch (1.6 mm) solder bead.

The decorative glass used for glass window artwork comes in different thicknesses, with ⅛ inches (3.18 mm), 5/32 inches (3.97 mm) and 3/16 (4.76 mm) inches being typical. If the desired foil tape side-wrap distance is 1/32 inches (0.8 mm) on each side of the glass, then a foil tape width of 3/16 inches (4.76 mm) will be needed for glass that is ⅛ inches (3.18 mm) thick, a foil tape width of 7/32 inches (5.56 mm) will be needed for glass that is 5/32 inches (3.97 mm) thick, and a foil tape width of ¼ inches (6.35 mm) will be needed for glass that is 3/16 inches (4.76 mm) thick.

It will be appreciated that the three different foil tape widths of 3/16 inches (4.76 mm), 7/32 inches (5.56 mm) and ¼ inches (6.35 mm) are not appreciably different in appearance to the human eye because they vary from each other by only 1/32 of an inch, which is so small as to be nearly impossible for most people to discern without measurement. Although rolls of copper foil tape are typically sold in plastic packaging marked with the foil tape width dimension, the foil tape roll itself is not so marked. Thus, once the foil tape roll is removed from its packaging, it is difficult to identify the foil tape width without measuring, which is inconvenient. If the glass assembly fabricator is working with several foil tape rolls with different foil tape widths, selecting the correct roll must be done with the upmost care to avoid choosing a foil tape roll whose tape width that is incompatible with the thickness of glass being used in the glass project.

Although the glass assembly fabricator can self-label each foil tape roll with its tape width dimension to keep track of the different thicknesses, applicant submits that a more effective solution is needed to address this problem.

### SUMMARY

A visually encoded foil tape roll for glass foiling includes a tape roll core and a quantity of flexible metallic foil tape wound around the tape roll core. The foil tape has a length dimension, a width dimension that is substantially less than the length dimension, and a thickness dimension that is substantially less than the width dimension. The foil tape includes a metal foil layer, an adhesive layer on one side of the metal foil layer, and a peelable adhesive backing layer disposed on the adhesive layer. The foil tape width dimension corresponds to an edge thickness of a glass edge onto which the foil tape is to be applied, and is sufficient such that the foil tape may cover the glass edge and wrap around adjacent side surfaces of the glass piece by a desired amount. The tape roll core displays a non-alphanumeric visual encoding selected to identify the width dimension of the foil tape and distinguish the foil tape roll from other foil tape rolls that include foil tape having different width dimensions and tape roll cores displaying different non-alphanumeric visual encodings selected to identify the different foil tape width dimensions.

In an embodiment, the foil tape roll may also display alphanumeric tape width dimension identifying information.

In an embodiment, a set having a plurality of the above-summarized visually encoded foil tape rolls may be provided. The foil tape of each foil tape roll in the set may have a unique foil tape width dimension that differs from the foil tape width dimension of other foil tape rolls in the set. The tape roll core of each foil tape roll core in the set may have a unique non-alphanumeric encoding that differs from the non-alphanumeric encoding of other tape roll cores in the set.

In an embodiment, a set of three visually encoded foil tape rolls may be provided. A first visually encoded foil tape roll may include a quantity of foil tape for application on a glass edge whose edge thickness is ⅛ inches, and may have a foil width dimension of 3/16 inches and a non-alphanumeric visual encoding that uniquely identifies the 3/16 inch foil width dimension. A second visually encoded foil tape roll may include a quantity of foil tape for application on a glass edge whose edge thickness is 5/32 inches, and may have a foil width dimension of 7/32 inches and a non-alphanumeric visual encoding that uniquely identifies the 7/32 inch foil width dimension. A third visually encoded foil tape roll may include a quantity of foil tape for application on a glass edge whose edge thickness is 3/16 inches, and may have a foil width dimension of ¼ inches and a non-alphanumeric visual encoding that uniquely identifies the ¼ inch foil width dimension.

In an embodiment, the tape roll core may display the non-alphanumeric visual encoding over its entire visible surface.

In an embodiment, the non-alphanumeric encoding may include a characteristic tape roll core color.

In an embodiment, the foil tape roll core may include a ring-shaped disk member having an outer ring surface on which the foil material is round, an inner ring surface defining a central bore, and a pair of annular side surfaces extending radially between the outer ring surface and the inner ring surface, the annular side surfaces being spaced apart from each other to define an axial thickness of the ring-shaped disk member that corresponds to the foil tape width dimension.

In an embodiment, the annular side surfaces of the tape roll core may include a radial dimension of not less than substantially ⅛ inches that is visible as a visually encoded ring when the tape roll is viewed from either side thereof.

In another aspect, a combination may be provided that includes a visually encoded foil tape roll as summarized above and a visually encoded foil tape dispenser that holds the foil tape roll so that the foil tape can be dispensed onto a glass edge. The foil tape dispenser may include a visually encoded foil tape dispensing tip having a dispensing track whose track width dimension matches the foil tape width dimension of the foil tape roll. The foil tape dispensing tip may display a non-alphanumeric visual encoding that matches the non-alphanumeric visual encoding displayed by the tape roll core of the foil tape roll, and uniquely identifies the dispensing track width dimension of the foil tape dispensing tip as being compatible with the foil tape roll.

In an embodiment, the foil tape dispensing tip may be detachably mounted to a body of the foil tape dispenser so that the dispensing tip can be removed from the dispenser body and replaced with a different dispensing tip having a different track width dimension and a different non-alphanumeric visual encoding for use with a different foil tape roll having a tape width corresponding to the different track width dimension and a core displaying the different non-alphanumeric visual encoding.

In an embodiment, the foil tape dispenser may be configured to hold different visually encoded foil tape rolls having different foil tape characteristic widths. The foil tape dispenser may include different detachably mountable dispensing tips that each have a dispensing track whose track width dimension matches the foil tape width dimension of one of the different visually encoded foil tape rolls, and displays a non-alphanumeric visual encoding that matches the non-alphanumeric visual encoding displayed by the tape roll core of same foil tape roll.

In an embodiment, the visually encoded foil tape roll is disposed inside the tape dispenser body, and the tape dispenser body includes a view port that allows the tape roll core of the foil tape roll to be viewed from outside the tape dispenser body in order to verify that the non-alphanumeric visual encoding displayed by the tape roll core matches the non-alphanumeric visual encoding displayed by the dispensing tip of the foil tape dispenser.

In an embodiment, the visually encoded foil tape roll and the dispensing tip may each display their non-alphanumeric visual encoding over their entire visible surface.

In an embodiment, the non-alphanumeric visual encoding of the visually encoded foil tape roll and the dispensing tip may respectively include a characteristic tape roll color and a characteristic dispensing tip color that match each other.

In an embodiment, the tape roll core may include a ring-shaped disk member having an outer ring surface on which the foil tape is round, an inner ring surface defining a central bore, and a pair of annular side surfaces extending radially between the outer ring surface and the inner ring surface and being spaced apart from each other to define an axial thickness of the ring-shaped disk member that corresponds to the foil tape width dimension. The tape dispenser may include a hub that is sized to fit the central bore and mount the tape roll core.

In an embodiment, the annular side surfaces of the tape roll core may include a radial dimension of not less than substantially ⅛ inches that is visible as a visually encoded ring when the tape roll is viewed from either side thereof, and the tape dispenser may include a view port through which the visually encoded ring may be seen when the tape roll is mounted on the hub.

In an embodiment, the foil tape dispenser may be sized so that it can be held by an adult human hand while dispensing the foil tape onto a glass edge. The tape roll core may have an outside diameter of not more than substantially 1 inch. The tape roll may have an outside diameter of not more than substantially 2.5-3.5 inches inches.

In another aspect, a glass foiling kit may be provided that includes a set of plural visually encoded foil tape rolls. A handheld foil tape dispenser and a set of plural visually encoded dispensing tips may also be provided as part of the kit.

In another aspect, a glass foiling method may include accessing a glass foiling kit that includes a set of plural visually encoded foil tape rolls, and which may also include a handheld foil tape dispenser and a set of plural visually encoded dispensing tips. The method includes selecting a piece of glass whose edge is to be foiled, the glass edge having a characteristic edge thickness, and selecting one of the plural foil tape rolls based on a non-alphanumeric visual encoding displayed by its tape roll core that identifies the width dimension of the foil tape as corresponding to the edge thickness of the selected piece of glass. The foil tape roll may be used with or without the foil tape dispenser. If the dispenser is not used, the method may include applying the foil tape of the selected foil tape roll onto the edge of the selected piece of glass by unwinding it from the foil tape roll. If the foil tape roll is used with the foil tape dispenser, the method may include selecting one of the plural foil tape dispensing tips based on a non-alphanumeric visual encoding displayed thereby matches the non-alphanumeric visual encoding displayed by the tape roll core of the selected foil tape roll, mounting the selected foil tape dispensing tip on the tape dispenser body of the foil tape dispenser, inserting the selected foil tape roll into the foil tape dispenser, and operating the foil tape dispenser to dispense the foil tape from the foil tape dispensing tip onto the edge of the selected piece of glass.

### BRIEF DESCRIPTION OF THE DRAWINGS

The foregoing and other features and advantages will be apparent from the following more particular description of example embodiments, as illustrated in the accompanying Drawings, in which:

FIG. 1A is a fragmented cross-sectional view showing an operational stage of a prior art glass fabrication process in which two pieces of glass having edges that are to be joined together have been foiled with foil tape and arranged with their foiled edges facing each other in spaced-apart relationship.

FIG. 1B is a fragmented cross-sectional view showing an operational stage of a prior art glass fabrication process in which the two pieces of glass of FIG. 1A are arranged for soldering with their respective foiled edges in mutual abutting relationship so that the respective foiled edge side sections thereof form a generally planar soldering surface on each side of the glass.

FIG. 1C is a fragmented cross-sectional view showing an operational stage of a prior art glass fabrication process in which the two pieces of glass of FIG. 1B have been soldered by applying solder to the soldering surfaces formed by their respective foil edge side sections.

FIG. 2A is a plan view showing an operational stage of a prior art glass fabrication process in which three pieces of glass whose respective edges have been foiled with foil tape are arranged so that the foiled edges of adjacent glass pieces that are to be soldered together face each other in spaced-apart relationship.

FIG. 2B is a plan view showing an operational stage of a prior art glass fabrication process in which the three pieces of glass of FIG. 2A are arranged so that the foiled edges of adjacent glass pieces that are to be soldered together are in mutual abutting relationship so that the respective foiled edge side sections thereof form a generally planar soldering surface on each side of the glass.

FIG. 2C is a plan view showing an operational stage of a prior art glass fabrication process in which three pieces of glass of FIG. 2B have been soldered by applying solder to the soldering surfaces formed by their respective foil edge side sections.

FIG. 3 is a plan view showing an example embodiment of a visually encoded foil tape roll that may be constructed in accordance with the present disclosure, with a tape roll core of the foil tape roll displaying a selected non-alphanumeric visual encoding that identifies a width dimension of the metallic foil tape wound thereon.

FIG. 4 is a side edge view of the foil tape roll of FIG. 3.

FIG. 5 is a perspective view of the foil tape roll of FIG. 3.

FIG. 6 is an exploded plan view of an end fragment of a flexible metallic foil tape that may be wound on the tape roll core of the foil tape roll of FIG. 3.

FIG. 7 is a side elevation view of the foil tape end fragment shown in FIG. 6.

FIG. 8 is a perspective view of another visually encoded foil tape roll that may be constructed accordance with the present disclosure, with a tape roll core of the foil tape roll displaying a selected non-alphanumeric visual encoding that is visually distinct from the non-alphanumeric visual encoding displayed by the tape roll core of the foil tape roll of FIG. 3 in order to identify a different width dimension of the metallic foil tape wound thereon.

FIG. 9 is a perspective view of another visually encoded foil tape roll that may be constructed accordance with the present disclosure, with a tape roll core of the foil tape roll displaying a selected non-alphanumeric visual encoding that is visually distinct from the non-alphanumeric visual encodings displayed by the tape roll cores of the foil tape rolls of FIG. 3 and FIG. 8 in order to identify a different width dimension of the metallic foil tape wound thereon.

FIG. 10A is a perspective view showing the tape roll core of the FIG. 3 tape roll.

FIG. 10B is a perspective view showing the tape roll core of the FIG. 8 tape roll.

FIG. 10C is a perspective view showing the tape roll core of the FIG. 9 tape roll.

FIG. 11A is a plan view showing the tape roll core of the FIG. 3 tape roll.

FIG. 11B is a plan view showing the tape roll core of the FIG. 8 tape roll.

FIG. 11C is a plan view showing the tape roll core of the FIG. 9 tape roll.

FIG. 12 is a side elevation view showing a handheld foil tape dispenser.

FIG. 13 is an exploded side elevation view of the foil tape dispenser of FIG. 10 showing a removable dispensing tip thereof separated from a tape dispenser body.

FIG. 14 is a front elevation view of the dispenser tip of the foil tape dispenser of FIG. 12, with a length of metallic foil tape being dispensed.

FIG. 15 is a top plan view of the dispenser tip of the foil tape dispenser of FIG. 12, with a length of metallic foil tape being dispensed.

FIG. 16 is a side elevation view of a tape dispenser body of the foil tape dispenser of FIG. 12 with the foil tape roll of FIG. 3 loaded being thereon and with a length of its metallic foil tape being dispensed from a dispensing tip of the foil tape dispenser, and further showing a side elevation view of a tape dispenser cover that attaches to the tape dispenser body in order to enclose the foil tape roll of FIG. 3 therein.

FIG. 17 is a side elevation view of the foil tape dispenser of FIG. 10 with the foil tape roll of FIG. 3 loaded therein and with a length of the tape roll's metallic foil tape being dispensed from a visually encoded dispensing tip of the foil tape dispenser that displays an non-alphanumeric visual encoding that matches the non-alphanumeric visual encoding displayed by the tape roll core of the FIG. 3 tape roll.

FIG. 18 is a perspective view showing the same subject matter shown in FIG. 17.

FIG. 19 is a perspective view of the visually encoded foil tape roll of FIG. 8 prior to being loaded in a tape dispenser.

FIG. 20 is a side elevation view of a tape dispenser body of the foil tape dispenser of FIG. 12 with the foil tape roll of FIG. 8 loaded being thereon and with a length of its metallic foil tape being dispensed from a visually encoded dispensing tip of the foil tape dispenser that displays an non-alphanumeric visual encoding that matches the non-alphanumeric visual encoding displayed by the tape roll core of the FIG. 8 tape roll.

FIG. 21 is a perspective view of the visually encoded foil tape roll of FIG. 9 prior to being loaded in a tape dispenser.

FIG. 22 is a side elevation view of a tape dispenser body of the foil tape dispenser of FIG. 12 with the foil tape roll of FIG. 9 loaded being thereon and with a length of its metallic foil tape being dispensed from a visually encoded dispensing tip of the foil tape dispenser that displays an non-alphanumeric visual encoding that matches the non-alphanumeric visual encoding displayed by the tape roll core of the FIG. 9 tape roll.

### DETAILED DESCRIPTION OF EXAMPLE EMBODIMENTS

Turning now to the drawing figures, which are not necessarily to scale, like reference numbers are used to represent like elements in all of the several views.

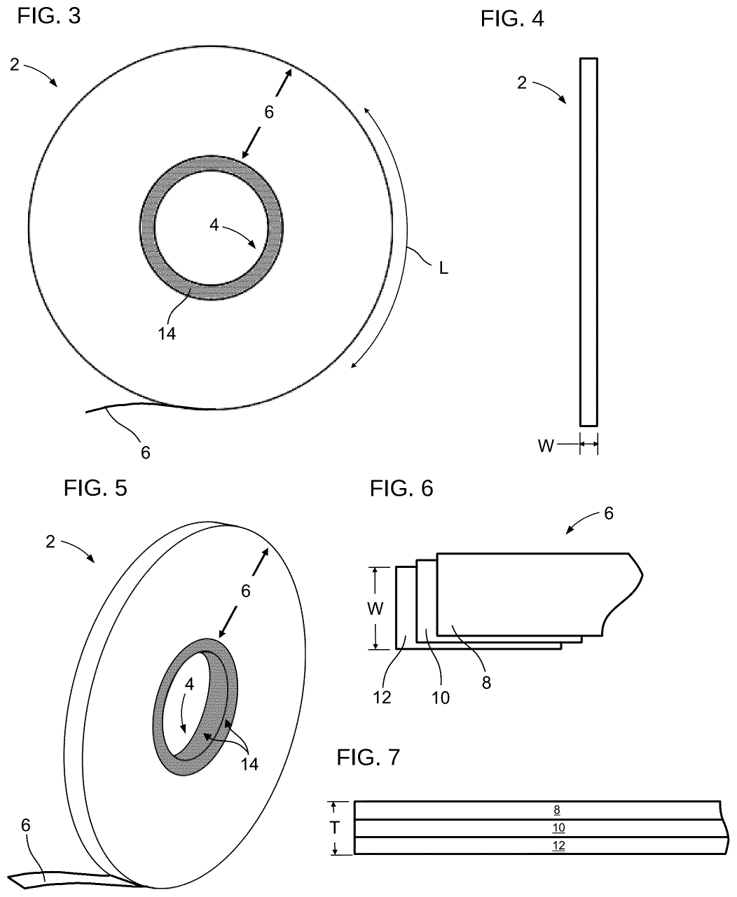

FIGS. 3-7 illustrate an example embodiment 2 of a visually encoded foil tape roll that is suitable for use in glass foiling during the fabrication of glass artwork, decorative glass products, and other multi-segment glass assemblies. The foil tape roll 2 includes a tape roll core 4 (FIGS. 3, 5) made from a material such as molded plastic, metal, composites, cardboard or other fibrous material, etc., that is sufficiently rigid to carry a quantity of flexible metallic foil tape 6 wound around the tape roll core.

The foil tape 6 has a length dimension “L” (FIG. 3) that dictates how many tape windings will be wound on the tape roll core 4. In an embodiment, a foil tape length of approximately 36 yards (33 meters) may be provided. Other desired lengths of the foil tape 6 may also be provided.

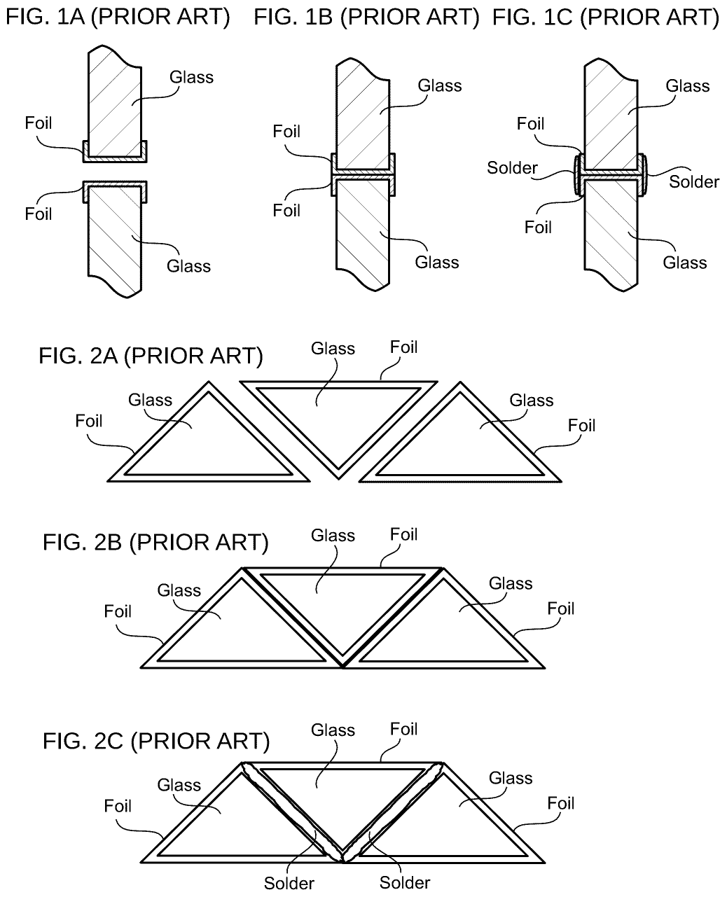

The foil tape 6 additionally has a width dimension “W” (FIGS. 4, 6) that is substantially less than the length dimension “L.” The foil tape width dimension “W” corresponds to an edge thickness of a glass edge to be foiled (e.g., in the manner shown in FIGS. 1 and 2), with the width dimension “W” being sufficient such that the foil tape 6 may cover the glass edge and wrap around adjacent side (face) surfaces of the glass piece by a desired amount, such as 1/32 inches (0.8 mm). By way of example only, the foil tape width dimension “W” may be one of the standard foil tape widths commonly used for decorative glass foiling, such as 3/16 inches (4.76 mm) (for a glass thickness of ⅛ inches (3.18 mm)), 7/32 inches (5.56 mm) (for a glass thickness of 5/32 inches (3.97 mm)) or ¼ inches (6.35 mm) (for a glass thickness of 3/16 inches (4.76 mm)).

The foil tape 6 further has a thickness dimension “T” (FIG. 7) that is substantially less than the width dimension “W.” By way of example only, the foil tape thickness dimension “T” may be 1 mil (0.0254 mm), which is a standard thickness of metallic foil tape used for decorative glass foiling.

As shown in FIGS. 6 and 7, the foil tape 6 includes a metal foil layer 8 made from a solderable metal (such as copper), an adhesive layer 10 disposed on the lower side of the metal foil layer, and a peelable adhesive backing layer 12 disposed on the lower side of the adhesive layer.

To assist the glass assembly fabricator quickly verify that the width dimension of the foil tape 6 is compatible with the edge thickness of the glass piece being foiled, the tape roll core 4 is configured to display a non-alphanumeric visual encoding 14. The visual encoding 14 may be provided in a number of ways, including as a color encoding, a pattern encoding, a surface texture encoding, any combination of the foregoing, or by using any other visually distinct indicator or combination of indicators that does not rely solely on alphanumeric characters (although alphanumeric characters could also be present if so desired). As will now be described, a variety of techniques may be used to form the tape roll core 4 with the visual encoding 14.

For a color encoding, a selected color or tint may be infused into the material that forms the tape roll core 4, such as a polymer into which a colorant has been infused or otherwise introduced. In that case, the entire viewable surface of the tape roll core 4 will bear the color encoding. Alternatively, a color encoding may be provided by applying a color coating onto the tape roll core 4, such as paint, dye, or other colored compound. In that case, the color coating may be applied to the entire viewable surface of the tape roll core 4, or limited to a selected viewable subregion thereof. As a further alternative, a color encoding may be provided by applying a colored film or sheet onto the tape roll core 4, such as a paper or plastic sticker or decal. As in the case of a color coating, the colored film or sheet may be applied to the entire viewable surface of the tape roll core 4, or limited to a selected viewable subregion thereof.

For a pattern encoding, a selected pattern may be applied in any of the ways described above in connection with color encodings, the only difference being that instead of infusing, coating or applying merely a color within or onto the tape roll core 4, the tape roll core may be infused or coated with, or have applied thereto, a pattern of lines, geometric shapes or other design elements, each of which may or may not be color encoded. As in the case of a color encoding, the selected pattern may be applied to the entire viewable surface of the tape roll core 4, or limited to a selected viewable subregion thereof.

For a surface texture encoding, a selected surface texture may be formed on or otherwise applied to the tape roll core 4. Examples include embossed or debossed patterns, shapes or other surface features that are created either during or after tape roll core formation, with such surface features being of any desired shape, size or configuration. As in the case of color and pattern encodings, the selected surface texture may be present on the entire viewable surface of the tape roll core 4, or limited to a selected viewable subregion thereof.

In the illustrated embodiment shown in FIGS. 3 and 5, the tape roll core 4 displays a characteristic color code as its non-alphanumeric visual encoding 14. For example, the color blue may be used (as shown by the use of a horizontal line hatching pattern that signifies the color blue per USPTO drawing guidelines). In particular, the tape roll core 4 as depicted in FIGS. 3 and 5 may be infused throughout the entire core body with the color blue, such as by molding it from a blue-colored polymer. This results in the entire viewable (and non-viewable) surface of the tape roll core 4 prominently displaying the color blue. By way of example only, the color blue may be selected to identify that the width of the foil tape 6 is 3/16 inches (4.76 mm) and is to be used for foiling glass whose thickness is ⅛ inches (3.18 mm).

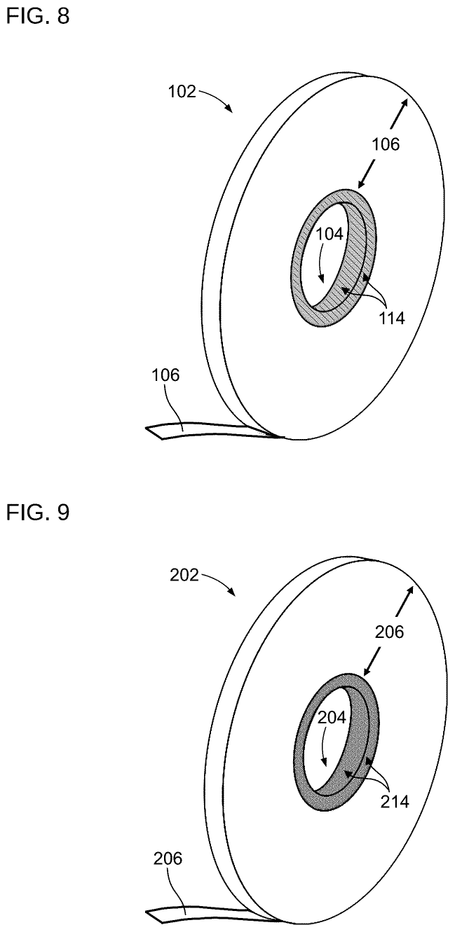

The selected color blue of the tape roll core 4 that identifies the 3/16 inch (4.76 mm) tape width dimension allows the glass assembly fabricator to readily distinguish the foil tape roll 2 from other foil tape rolls that are wound with foil tape having different width dimensions, and which have tape roll cores displaying different non-alphanumeric visual encodings that identify the different foil tape width dimensions. Examples of such other foil tape rolls are shown in FIGS. 8 and 9. FIG. 8 illustrates a visually encoded foil tape roll 102 whose tape roll core 104 displays the color green as its non-alphanumeric visual encoding 114 (as shown by the use of a diagonal line hatching pattern that signifies the color green per USPTO drawing guidelines). FIG. 9 illustrates a visually encoded foil tape roll 202 whose tape roll core 204 displays the color orange as its non-alphanumeric visual encoding 214 (as shown by the use of a diagonal cross-hatch pattern that signifies the color orange per USPTO drawing guidelines).

As noted, by way of example only, the foil tape 6 of the foil tape roll 2 may be designed for application on a glass edge whose edge thickness is ⅛ inches (3.18 mm), and may have a foil width dimension of 3/16 inches (4.76 mm) and a non-alphanumeric visual encoding of blue color that uniquely identifies the 3/16 inch (4.76 mm) foil width dimension.

By way of further example, the foil tape 106 of the foil tape roll 102 may be designed for application on a glass edge whose edge thickness is 5/32 inches (3.97 mm), and may have a foil width dimension of 7/32 inches (5.56 mm) and a non-alphanumeric visual encoding 114 of green color that uniquely identifies the 7/32 inch (5.56 mm) foil width dimension.

By way of still further example, the foil tape 206 of the foil tape roll 202 may be designed for application on a glass edge whose edge thickness is 3/16 inches (4.76 mm), and may have a foil width dimension of ¼ inches (6.35 mm) and a non-alphanumeric visual encoding 214 of orange color that uniquely identifies the ¼ inch (6.35 mm) foil width dimension.

In an embodiment, the three visually encoded foil tape rolls 2, 102 and 202 may be provided as a set of plural visually encoded foil tape rolls. Each foil tape roll 2, 102 and 202 in the set may respectively include a quantity of foil tape 6, 106 or 206 for application on a glass edge whose edge thickness is ⅛ inches (3.18 mm), 5/32 inches (3.97 mm) or 3/16 inches (4.76 mm), respectively. The foil tapes 6, 106 and 206 may have respective a foil width dimensions of 3/16 inches (4.76 mm), 7/32 inches (5.56 mm) and ¼ inches (6.35 mm). The tape roll cores 4, 104 and 204 of the foil tape rolls 2, 102 and 202 may have a respective non-alphanumeric visual encodings 14, 114 and 214 of blue, green and orange color that uniquely identify the 3/16 inch (4.76 mm), 7/32 inch (5.56 mm) and ¼ inch (6.35 mm) foil width dimensions. Although not shown, additional visually encoded foil tape rolls having other foil tape width dimensions and other characteristic non-alphanumeric visual encodings may also be provided as part of the same set, or as part of a different set of plural visually encoded foil tape rolls that may include some, all or none of the tape rolls 2, 102 and 202.

In an embodiment, the characteristic blue, green and orange colors of the tape roll cores 4, 104 and 204 may be provided by forming them from correspondingly colored materials, such as colored polymers. This will result in the non-alphanumeric encodings 14, 114 and 214 of the tape roll cores 4, 104 and 204 being displayed over their entire visible (and non-visible) surfaces.

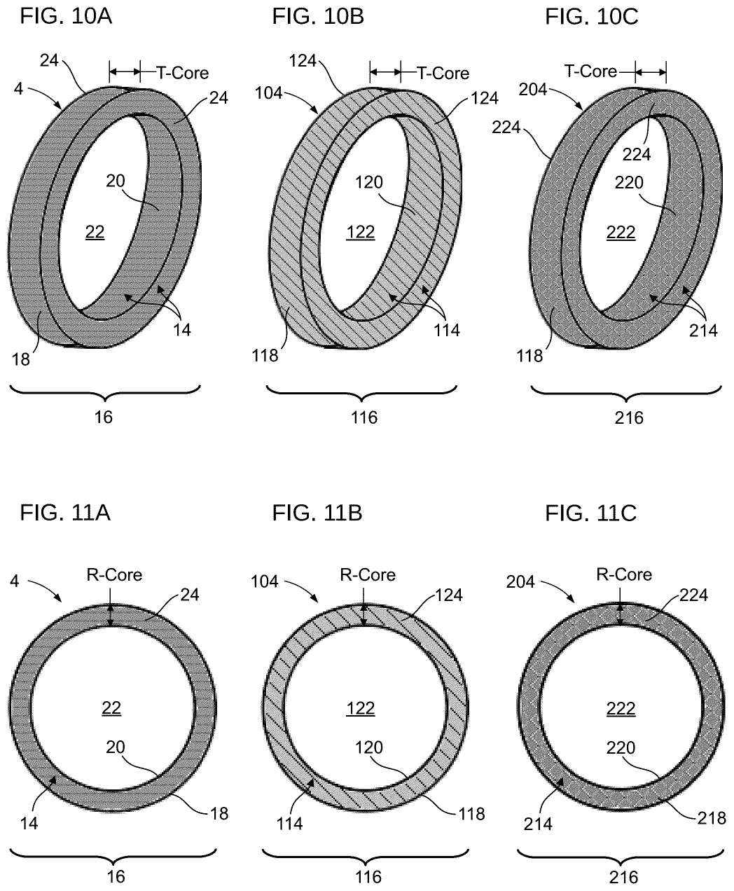

As shown in FIGS. 10A, 10B, 10C and 11A, 11B, 11C, each tape roll core 4, 104 and 204 may be respectively formed as a ring-shaped disk member 16, 116 and 216. The ring-shaped disk members 16, 116 and 216 may respectively include a radial outer ring surface 18, 118 and 218 on which foil material is wound and a radial inner ring surface 20, 120 and 220 defining a central circular bore 22, 122 and 222. A pair of annular side surfaces 24, 124 and 224 are also respectively defined on the ring-shaped disk members 16, 116 and 216.

The annular side surfaces 24, 124 and 224 extend radially between the outer ring surface 18, 118 and 218 and the inner ring surface 20, 120 and 220 of the ring-shaped disk members 16, 116 and 216. As shown in FIGS. 10A, 10B and 10C, the annular side surfaces 24, 124 and 224 are spaced apart from each other to define an axial thickness dimension “T-Core” of the ring-shaped disk members 16, 116 and 216. In an embodiment, the axial thickness dimension “T-Core” corresponds to the foil tape width dimension “W” shown in FIGS. 4 and 6. However, this is not a requirement. For example, if the inner ring surfaces 20, 120 and 220 are color-coded as shown in FIGS. 10A, 10B and 10C, or otherwise visually encoded, it may be desirable to maximize the “T-Core” thickness dimension in order to increase the visibility of the encoding. In that case, the ring-shaped disk members 16, 116 and 216 could be sized so that the “T-Core” thickness dimension is larger than the foil tape width dimension “W.”

As shown in FIGS. 11A, 11B and 11C, the annular side surfaces 24, 124 and 224 also have a radial dimension “R-Core” defined by the radial spacing between the outer ring surface 18, 118 and 218 and the inner ring surface 20, 120 and 220 of the ring-shaped disk members 16, 116 and 216. Assuming that the annular side surfaces 24, 124 and 224 are color-coded as shown in FIGS. 11A, 11B and 11C, or otherwise visually encoded, the “R-Core” radial dimension will (like the “T-Core axial dimension) also impact the visibility of the encoding. As such, it may be advantageous to maximize the “R-Core” radial dimension to the extent that this is feasible, and to avoid making the annulus defined by the ring-shaped disk members 16, 116 and 216 so thin as to impair the visibility of the encoding. In an embodiment, an “R-Core” radial dimension of not less than substantially ⅛ inches (3.18 mm) may be used. The tape roll cores 4, 104 and 204 may then be readily seen as visually encoded rings when the tape rolls 2, 102 and 202 are viewed from either side thereof.

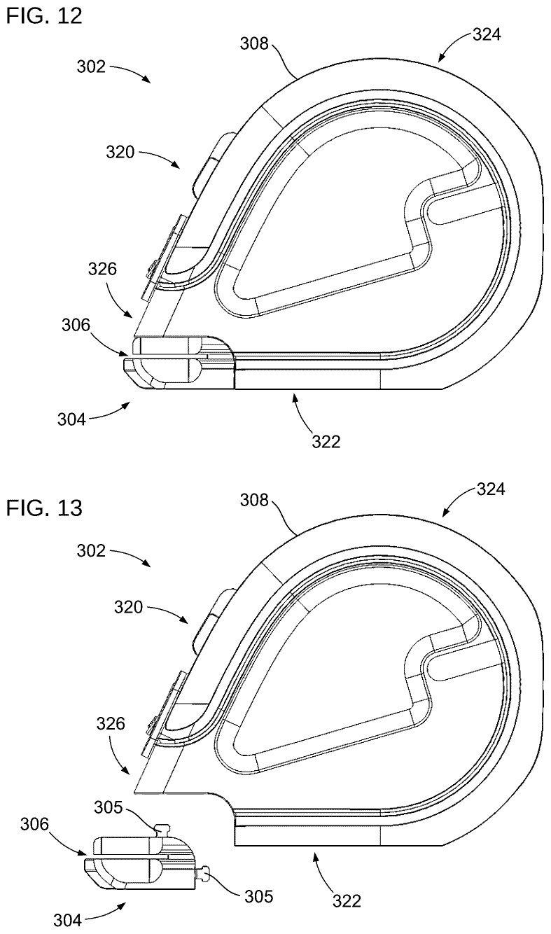

In an embodiment, the visually encoded tape rolls 2, 102 and 202, or any of them, may be optionally used in combination with a handheld foil tape dispenser 302, shown in FIGS. 12-13. The foil tape dispenser 302 is configured to hold a single one of the foil tape rolls 2, 102 or 202 so that the foil tape 6, 106 or 206 wound thereon can be dispensed onto a glass edge. The foil tape dispenser 302 may include a foil tape dispensing tip 304 having a dispensing track 306. As shown in FIG. 13, the dispensing tip 304 may be removably mounted to a main housing 308 of the foil tape dispenser 302 that is sized and configured to hold any of the tape rolls 2, 102, 202. Any suitable attachment arrangement may be used, including but not limited to an arrangement that includes one or more connector structures 305 on the foil tape dispenser tip 304 that engage counterpart connector structures (not shown) on the tape dispenser housing 308.

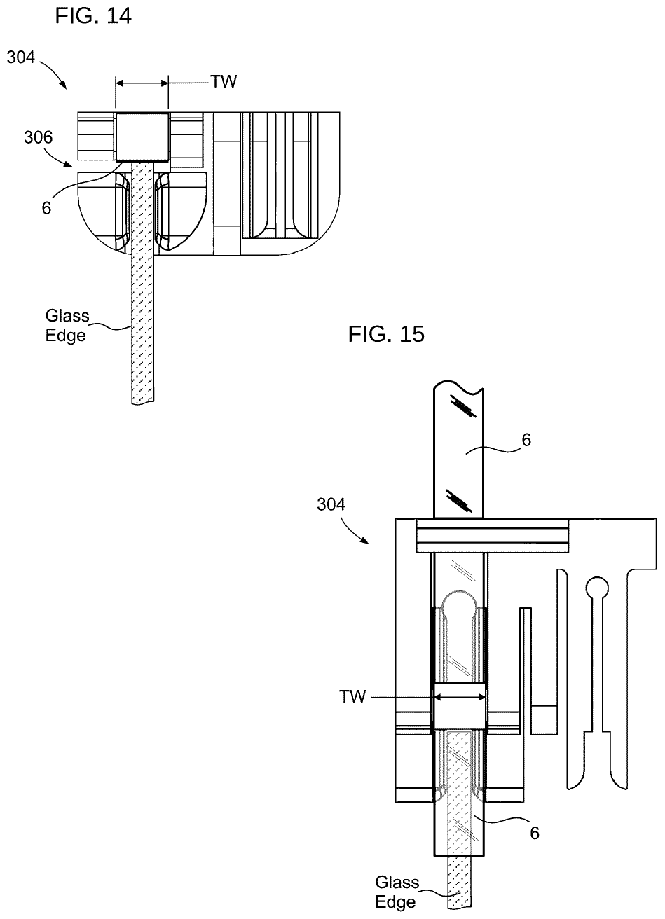

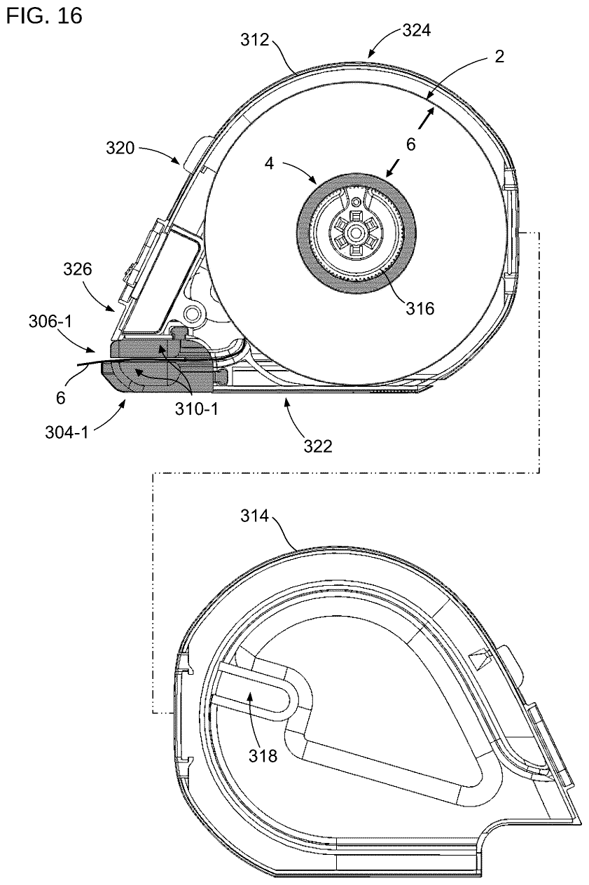

As shown in FIGS. 14-15, the foil tape dispensing tip 304 may have a track width dimension “TW” that matches the foil tape width dimension “W” of one of the foil tape rolls 2, 102 or 202. Because the foil tape dispensing tip 304 is removable from the housing 308 of the foil tape dispenser 302, different dispensing tips having different track width dimensions “TW” may be selectively mounted to the tape dispenser housing to match the particular foil tape roll 2, 102 or 202 that is currently disposed within the housing.

As will now be described, the foil tape dispensing tip 304 may be implemented as a visually encoded foil tape dispenser tip that displays a non-alphanumeric visual encoding. When the visually encoded foil tape dispenser tip 304 is mounted on the tape dispenser housing 308, the foil tape dispenser 302 becomes a visually encoded foil tape dispenser. The visually encoded foil tape dispenser tip 304 may be visually encoded using any of the various techniques described above for visually encoding tape roll cores. For example, the visual encoding may be provided as a color encoding, a pattern encoding, a surface texture encoding, or any combination of the foregoing, or by using any other visually distinct indicator or combination of indicators that does not rely solely on alphanumeric characters (although alphanumeric characters could also be present if so desired).

In an embodiment, different foil dispensing tips 304 may be provided for use in combination with the foil tape dispenser 302, with each dispensing tip displaying a particular non-alphanumeric visual encoding and having a particular track with dimension “TW” designed for use with a different one of the foil tape rolls 2, 102 or 202. The non-alphanumeric visual encoding of each foil tape dispensing tip 304 may be selected to match the non-alphanumeric visual encoding 14, 114 or 214 of the tape roll core 4, 104 or 204 of whichever foil tape roll 2, 102 or 202 is carried by the foil tape dispenser 302. Thus, a glass foiling kit may be provided that includes a set of plural visually encoded foil tape rolls 2, 102 and 202, a handheld foil tape dispenser 302, and a set of plural visually encoded dispensing tips 304.

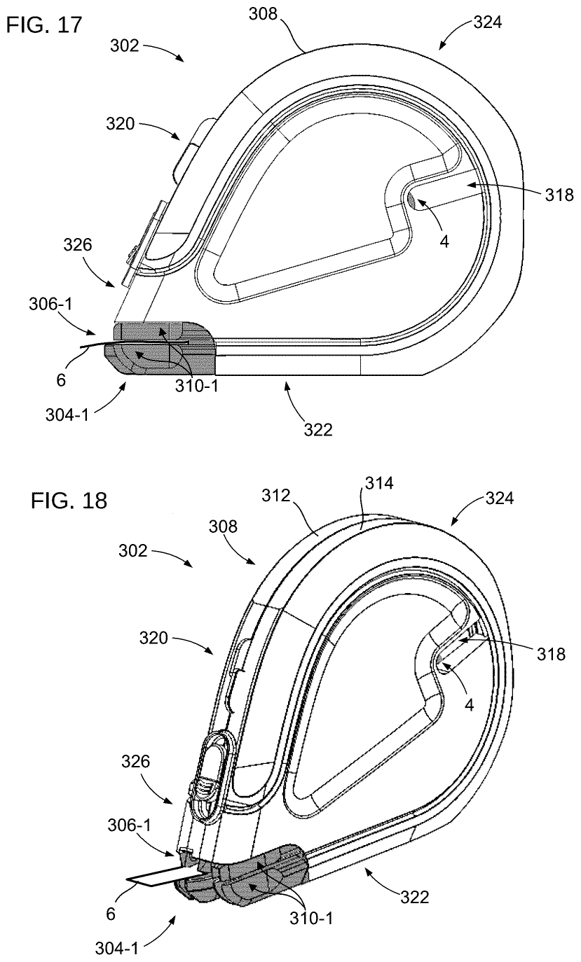

FIGS. 16-18 depict one dispensing tip visual encoding example in which a non-alphanumeric visual encoding 310-1 displayed by a foil tape dispensing tip 304-1 is provided by fabricating the dispensing tip from a color coded material whose color is blue to match the blue color coding of the tape roll core 4 shown in FIGS. 10A and 11A, which is in incorporated in the foil tape roll 2 of FIGS. 3-7. The blue color code 310-1 of the foil tape dispensing tip 304-1 uniquely identifies the width dimension “TW” of its dispensing track (designated as 306-1), which may be substantially 3/16 inches (4.76 mm) to accommodate the corresponding width dimension “W” of 3/16 inches (4.76 mm) associated with the foil tape 6 on the foil tape roll 2. The blue color code 310-1 of the foil tape dispensing tip 304-1 thereby provides visual confirmation that this dispensing tip is compatible with the foil tape roll 2, whose tape roll core 4 also displays a blue color code, as can be seen in FIGS. 10A and 11A. This color coordination characteristic is best seen in FIG. 16.

FIG. 16 additionally illustrates certain structural features that may be used to implement an embodiment of the foil tape dispenser 302, and particularly the tape dispenser housing 308. In this illustrated embodiment, which is shown for purposes of example only and not by way of limitation, the tape dispenser housing 308 may be formed from a tape dispenser body 312 that holds one of the foil tape rolls 2, 102 or 202, and a removable tape dispenser cover 314 that can be hinged to the tape dispenser body or attached thereto in any other desired manner to facilitate insertion and removal of the foil tape roll 2, 102 or 202. In an embodiment, the tape dispenser body 312 serves as a dispensing tip mount point where the foil tape dispensing tip 304-1 mounts to the tape dispenser housing 308, whereas the tape dispenser cover 314 does not. In this way, the tape dispenser cover 314 may be opened and closed without restriction.

In an embodiment, the major structural components of the foil tape dispenser 302 may be constructed from molded plastic of suitable rigidity and strength. Other embodiments could utilize other structural materials in lieu of plastic for the major structural components, such as metals or composites, depending on manufacturer preferences.

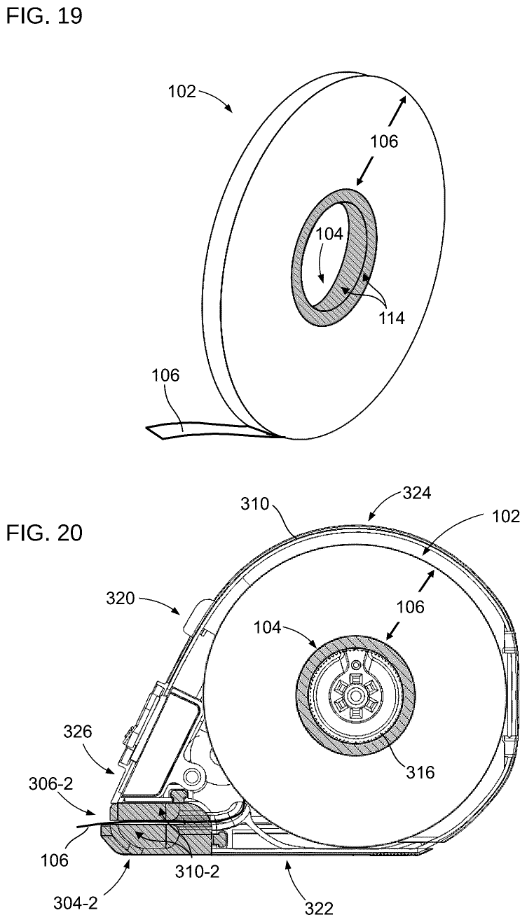

FIGS. 19-20 depict another dispensing tip visual encoding example in which a visual encoding 310-2 displayed by a foil tape dispensing tip 304-2 is provided by fabricating the dispensing tip from a color coded material whose color is green to match the green color coding of the tape roll core 104 shown in FIGS. 10B and 11B, which is in incorporated in the foil tape roll 102 of FIG. 8. The green color code of the foil tape dispensing tip 304-2 uniquely identifies the width dimension “TW” of its dispensing track 306-2, which may be substantially 7/32 inches (5.56 mm) to accommodate the corresponding width dimension “W” of 7/32 inches (5.56 mm) associated with the foil tape 106 on the foil tape roll 102. The green color code of the foil tape dispensing tip 304-2 thereby provides visual confirmation that this dispensing tip is compatible with the foil tape roll 102, whose tape roll core 104 also displays a green color code, as can be seen in FIGS. 10B and 11B.

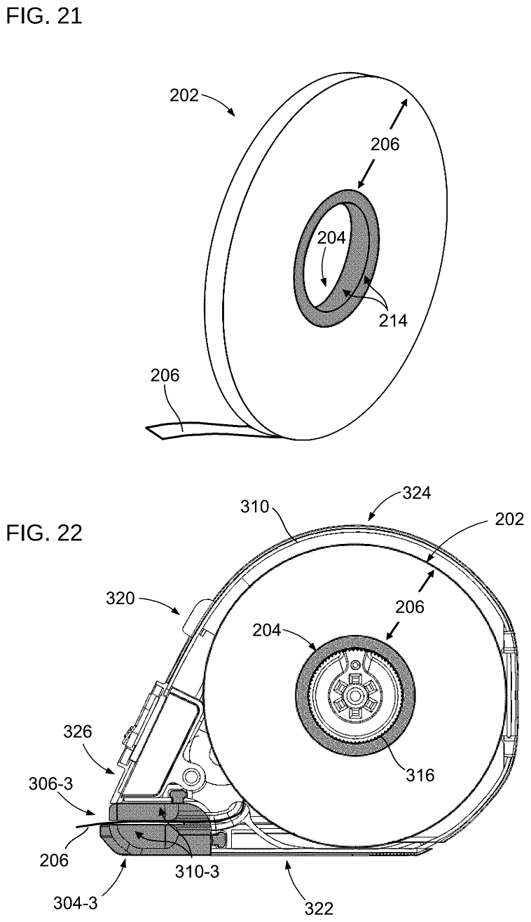

FIGS. 21-22 depict another dispensing tip visual encoding example which a visual encoding 310-3 displayed by a foil tape dispensing tip 304-3 is provided by fabricating the dispensing tip from a color coded material whose color is orange to match the orange color coding of the tape roll core 204 shown in FIGS. 10C and 11C, which may be substantially ¼ inches (6.35 mm) to accommodate the corresponding width dimension “W” of ¼ inches (6.35 mm) associated with the foil tape 206 on the foil tape roll 202. The orange color code of the foil tape dispensing tip 304-3 thereby provides visual confirmation that this dispensing tip is compatible with the foil tape roll 202, whose tape roll core 204 also displays an orange color code, as can be seen in FIGS. 10C and 11C.

As shown in FIGS. 16-18, 20 and 22, the foil tape dispensing tips 304-1, 304-2 and 304-3 each display their respective non-alphanumeric visual encodings 310-1, 310-2 and 310-3 as a color code that extends over their entire visible surface. That said, it will be appreciated that the dispensing tips 304-1, 304-2 and 304-3 could display a color code that extends over less than their entire visible surface. Moreover, as previously discussed, the non-alphanumeric visual encodings displayed by the dispensing tips 304-1, 304-2 and 304-3 need not be a color code at all, and could instead be any of the alternative types of non-alphanumeric visual encodings previously discussed in connection with the tape roll cores 4, 104 and 204. It will be appreciated, however, that the non-alphanumeric visual encodings displayed by the dispensing tips 304-1, 304-2 and 304-3 may be most effective when they match whatever non-alphanumeric visual encoding is displayed by a corresponding one of the tape roll cores 4, 104 and 204.

As can be seen in FIGS. 16, 20 and 22, an additional structural feature of the foil tape dispenser 302 is that the tape dispenser body 312 may incorporate a circular hub 316 that is sized to fit and accommodate the central circular bore 22, 122 or 222 of whichever foil tape roll core 4, 104 or 204 is carried therein. This secures the associated tape roll 2, 102 or 202 at a fixed location while allowing it to rotate so that the foil tape 6, 106 or 206 wound thereon may be spooled out during foiling. As further shown in FIGS. 16-18, the tape dispenser cover 314 that forms part of the tape dispenser housing 308 may include a view port 318 that allows the tape roll core 4, 104 or 204 of the foil tape roll 2, 102 or 202 to be viewed from outside of the housing. This allows the glass assembly fabricator to quickly verify that the non-alphanumeric visual encoding 14, 114 or 214 displayed by whichever tape roll core 4, 104 or 204 is disposed on the hub 316 matches the non-alphanumeric visual encoding 310-1, 310-2 or 310-3 displayed by whichever dispensing tip 304-1, 304-2 or 304-3 is mounted on the tape dispenser body 310.

As previously described in connection with FIGS. 11A, 11B and 11C, the annular side surfaces 24 of the tape roll cores 4, 104 and 204 may have an “R-Core” radial dimension (e.g. of not less than substantially ⅛ inches (3.18 mm)) that is visible as a visually encoded ring when the tape roll is viewed from either side thereof. The view port 318 may be correspondingly sized and configured (e.g., as a slot) so that some or all of the visually encoded ring displayed by the tape roll core 4, 104 or 204 may be seen when the tape roll core is mounted on the tape dispenser hub 316 and the tape dispenser cover 314 is closed. When configured in this manner, the view port 318 also reveals the amount of foil tape remaining on the foil tape roll without having to open the tape dispenser cover 314.

In an embodiment, the foil tape dispenser 302 may be sized so that it can be held by an adult human hand (not shown) while dispensing the foil tape 6, 106 or 206 onto a glass edge. As best shown in FIGS. 12-13, the tape dispenser housing 308 may include a thumb-receiving edge portion 320 arranged to engage a thumb of the hand, and a finger-receiving edge portion 322 arranged to engage some or all of the remaining fingers of the hand. As additionally shown in FIGS. 16, 20 and 22, the thumb-receiving edge portion 320 and the finger-receiving edge portion 322 converge toward each other from a tape roll compartment 324 defined by the tape dispenser body 312 to a foil-dispensing portion end 326 of the body where the foil tape dispensing tip 304 is situated. As shown in FIG. 16, the tape dispenser cover 314 is shaped in the same manner.

As can be envisioned from FIG. 18, when the foil tape dispenser 302 is held by a user with the user's thumb on the thumb-receiving edge portion 320 and the user's remaining fingers on the finger-receiving edge portion 322, either the tape dispenser body 312 or the tape dispenser cover 314 will engage one of the user's palms, depending on the hand (left or right) in which the foil tape dispenser is held. Advantageously, the tape dispenser housing 308 is ergonomically sized and shaped for efficient single-handed operation. For example, the maximum height of the tape dispenser housing 308 (i.e., from top to bottom) may range between approximately 3-4 inches. The maximum thickness of the tape dispenser housing 308 (i.e., from side to side) may range between approximately 1-1.2 inches. As previously noted, the thumb-receiving edge portion 320 and the finger-receiving edge portion 322 converge toward each other to provide a tapered shape that facilitates natural gripping between the thumb and fingers.

Regardless of whether or not the foil tape rolls 2, 102 and 202 are to be used in combination with the foil tape dispenser 302, the tape roll may be produced with a reduced form factor to provide a compact size that is compatible with one-handed usage. The glass assembly fabricator may thereby foil a glass edge while holding the glass in one hand, and while using the other hand to hold either the tape roll 2, 102 or 202 by itself, or the foil tape dispenser 303 with the tape roll disposed inside the dispenser body 312. For example, the foil tape rolls 2, 102 and 202 may have an outside diameter that does not exceed substantially 2.5-3.5 inches (63-90 mm) so that the tape rolls will fit within the tape dispenser housing 308 or within the palm of an adult human hand if the foil tape dispenser 302 is not used. This distinguishes the foil tape rolls 2, 102 and 104 from conventional foil tape rolls, which typically have an outside diameter of 4-5 inches (102-127 mm), which renders them unsuitable for use in a hand-held foil tape dispenser designed for single-handed use, and may also render them unsuitable or unwieldy for single-handed use without a foil tape dispenser.

To ensure that a sufficient length of foil tape 6 can be wound within the constraints of the small form factor of the foil tape rolls 2, 102 and 202, the tape roll cores 4, 104 and 204 may also have a small form factor. For example, the tape roll cores 4, 104 and 204 may have an outside diameter of that does not exceed substantially 1 inch, and may have an inside diameter selected to enable the inner surface of the tape roll cores to rotatably engage the tape dispenser hub 316. By comparison, conventional foil tape rolls typically have a tape roll core whose outside diameter is 3 inches or more. In such foil tape rolls, the inside diameter of the tape roll core is only slightly less than the outside diameter. This accommodates the conventional foiling technique wherein the user grasps the foil tape roll with the fingers of their hand passing through the open interior of the tape roll core.

In an embodiment, a glass foiling kit that includes the foil tape dispenser 302, one or more of the visually encoded foil tape rolls 2, 102 and 202, and one or more of the visually encoded foil tape dispensing tips 304-1, 304-2 and 304-3, may be used to practice a glass foiling method. The method may include (in no particular order) accessing the kit and selecting a piece of glass whose edge is to be foiled, and which has a characteristic edge thickness. One of foil tape rolls 2, 102 or 202 may be selected based on the visual encoding 14, 114 or 214 displayed by its tape roll core 4, 104 or 204 to identify the width dimension of the foil tape 6 wound thereon. The visual encoding 14, 114 or 214 will readily indicate to the user that the tape width of the selected foil tape roll 2, 102 or 202 corresponds to the edge thickness of the selected piece of glass, such that the user does not have to measure the tape width or refer to the original tape roll packaging information to select the correct foil tape roll. One of the foil tape dispensing tips 304-1, 304-2 or 304-3 may be selected whose visual encoding 314-1, 314-2 or 314-3 matches to the visual encoding of the tape roll core 4, 104 or 204 of the selected foil tape roll 2, 102 or 202. The selected foil tape dispensing tip 304-1, 304-2 or 304-3 may be mounted on the tape dispenser housing 308 of the foil tape dispenser 302 (e.g., by attaching it to the tape dispenser body 312). The foil tape dispenser 302 may then be operated to dispense the foil tape 6 from the mounted foil tape dispensing tip 304-1, 304-2 or 304-3 onto the edge of the selected piece of glass.

Accordingly, embodiments of a visually encoded foil tape roll have been disclosed that may be provided alone or as a set of plural visually encoded foil tape rolls. Also disclosed was a handheld visually encoded foil tape dispenser, a glass foiling kit, and a glass foiling method that uses the kit.

Reference in the present disclosure to an “embodiment” means that a particular feature, structure or characteristic described in connection with the embodiment may be included in at least one embodiment of the disclosed device. Thus, the appearances of the term “embodiment” in various places throughout the specification are not necessarily all referring to the same embodiment.

For purposes of explanation, specific configurations and details have been set forth herein in order to provide a thorough understanding of the present invention. However, it will be apparent to one of ordinary skill in the art that embodiments of the present invention may be practiced without the specific details presented herein. Furthermore, well-known features may have been omitted or simplified in order not to obscure the present invention. Various examples have been given throughout this description. These examples are merely descriptions of specific embodiments of the invention. The scope of the claimed subject matter is not limited to the examples given.

As used herein, the terms such as “upper,” “lower,” “top,” “bottom,” “vertical,” “vertically,” “lateral,” “laterally,” “inner,” “outer,” “outward,” “inward,” “front,” “frontward,” “forward,” “rear,” “rearward,” “upwardly,” “downwardly,” “inside,” “outside,” “interior,” “exterior,” and other orientational descriptors are intended to facilitate the description of the example embodiments of the present disclosure, and are not intended to limit the structure of the example embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Terms of rough approximation, such as “generally,” are understood by those of ordinary skill to refer to a characteristic or feature of that bears resemblance to something, such that it is reasonable to draw a comparison to facilitate understanding, without requiring that the characteristic or feature be exactly the same, or even substantially the same, as the thing to which it is compared.

Although example embodiments have been shown and described, it should be apparent that many variations and alternate embodiments could be implemented in accordance with the present disclosure. It is understood, therefore, that the invention is not to be limited except in accordance with the appended claims and equivalents thereof.

What is claimed is:

1. A visually encoded foil tape roll for glass foiling, comprising:
a tape roll core;
a quantity of flexible metallic foil tape wound around the tape roll core;
the foil tape having a length dimension, a width dimension that is substantially less than the length dimension, and a thickness dimension that is substantially less than the width dimension;
the foil tape comprising a metal foil layer, an adhesive layer on one side of the metal foil layer, and a peelable adhesive backing layer disposed on the adhesive layer;
the foil tape width dimension corresponding to an edge thickness of a glass edge onto which the foil tape is to be applied and being sufficient such that the foil tape may cover the glass edge and wrap around adjacent side surfaces of the glass piece by a desired amount; and
the tape roll core displaying a non-alphanumeric visual encoding selected to uniquely identify the width dimension of the foil tape and distinguish the foil tape roll from other foil tape rolls that comprise foil tape having different width dimensions and tape roll cores displaying different non-alphanumeric visual encodings selected to uniquely identify the different foil tape width dimensions.

2. The visually encoded foil tape roll of claim 1, wherein the foil tape roll also displays alphanumeric tape width dimension identifying information.

3. A set comprising a plurality of the visually encoded foil tape roll of claim 1, wherein the foil tape of each foil tape roll in the set has a unique foil tape width dimension that differs from the foil tape width dimension of other foil tape rolls in the set, and wherein the tape roll core of each foil tape roll core in the set has a unique non-alphanumeric encoding that differs from the non-alphanumeric encoding of other tape roll cores in the set.

4. A set of three of the visually encoded foil tape roll of claim 1, comprising:
a first visually encoded foil tape roll comprising a quantity of foil tape for application on a glass edge whose edge thickness is ⅛ inches, and having a foil width dimension of 3/16 inches and a non-alphanumeric encoding that uniquely identifies the 3/16 inch foil width dimension;
a second visually encoded foil tape roll comprising a quantity of foil tape for application on a glass edge whose edge thickness is 5/32 inches, and having a foil width dimension of 7/32 inches and a non-alphanumeric encoding that uniquely identifies the 7/32 inch foil width dimension; and
a third visually encoded foil tape roll comprising a quantity of foil tape for application on a glass edge whose edge thickness is 3/16 inches, and having a foil width dimension of ¼ inches and a non-alphanumeric encoding that uniquely identifies the ¼ inch foil width dimension.

5. The visually encoded foil tape roll of claim 1, wherein the tape roll core displays the non-alphanumeric visual encoding over its entire visible surface.

6. The visually encoded foil tape roll of claim 1, wherein the non-alphanumeric visual encoding comprises a characteristic tape roll core color.

7. The visually encoded foil tape roll of claim 1, wherein the tape roll core comprises a ring-shaped disk member having an outer ring surface on which the foil tape is wound, an inner ring surface defining a central bore, and a pair of annular side surfaces extending radially between the outer ring surface and the inner ring surface, the annular side surfaces being spaced apart from each other to define an axial thickness of the ring-shaped disk member that corresponds to the foil tape width dimension.

8. The visually encoded foil tape roll of claim 7, wherein the annular side surfaces of the ring-shaped disk member comprise a radial dimension of not less than substantially ⅛ inches that is visible as a visually encoded ring when the tape roll is viewed from either side thereof.

9. The visually encoded foil tape roll of claim 1, wherein the tape roll core has an outside diameter of not more than substantially 1 inch and the tape roll has an outside diameter of not more than substantially 2.5-3.5 inches so that it can be held by an adult human hand while dispensing the foil tape onto a glass edge.

10. The visually encoded foil tape roll of claim 1, in combination with a visually encoded foil tape dispenser that holds the foil tape roll so that the foil tape can be dispensed onto a glass edge, the foil tape dispenser comprising a visually encoded foil tape dispensing tip having a dispensing track whose track width dimension matches the foil tape width dimension of the foil tape roll, the foil tape dispensing tip further having a non-alphanumeric visual encoding that matches the non-alphanumeric visual encoding displayed by the tape roll core of the foil tape roll, and uniquely identifies the dispensing track width dimension of the foil tape dispensing tip as being compatible with the foil tape roll.

11. The combination of claim 10, wherein the foil tape dispensing tip is detachably mounted to a body of the foil tape dispenser so that the dispensing tip can be removed from the tape dispenser body and replaced with a different dispensing tip having a different track width dimension and a different non-alphanumeric visual encoding for use with a different foil tape roll having a tape width dimension corresponding to the different track with dimension and a core displaying the non-alphanumeric visual encoding corresponding to the different non-alphanumeric visual encoding.

12. The combination of claim 11, wherein the foil tape dispenser is configured to hold different visually encoded foil tape rolls having different foil tape width dimensions, and wherein the foil tape dispenser comprises different detachably mountable dispensing tips that each have a dispensing track whose track width dimension matches the foil tape width dimension of one of the different visually encoded foil tape rolls, and displays a non-alphanumeric visual encoding that matches the non-alphanumeric visual encoding displayed by the tape roll core of same foil tape roll.

13. The combination of claim 12, wherein the visually encoded foil tape roll is disposed inside the tape dispenser body, and wherein the tape dispenser body comprises a view port that allows the tape roll core of the foil tape roll to be viewed from outside the tape dispenser body in order to verify that the non-alphanumeric visual encoding displayed by the tape roll core matches the non-alphanumeric visual encoding displayed by the dispensing tip of the foil tape dispenser.

14. The combination of claim 11, wherein the visually encoded foil tape roll and the dispensing tip each display their non-alphanumeric visual encoding over their entire visible surface.

15. The combination of claim 11, wherein the non-alphanumeric visual encoding of the visually encoded foil tape roll and the dispensing tip respectively comprise a characteristic tape roll color and a characteristic dispensing tip color that match each other.

16. The combination of claim 11, wherein the tape roll core comprises a ring-shaped disk member having an outer ring surface on which the foil tape is round, an inner ring surface defining a central bore, and a pair of annular side surfaces extending radially between the outer ring surface and the inner ring surface and being spaced apart from each other to define an axial thickness of the ring-shaped disk member that corresponds to the foil tape width dimension, and further wherein the the tape dispenser comprises a hub that is sized to fit the central bore and mount the tape roll core.

17. The combination of claim 16, wherein the annular side surfaces of the tape roll core comprise a radial dimension of not less than substantially ⅛ inches that is visible as a visually encoded ring when the tape roll is viewed from either side thereof, and further wherein the foil tape dispenser comprises a view port through which the visually encoded ring may be seen when the tape roll is mounted on the hub.

18. The combination of claim 17, wherein:
the foil tape dispenser is sized so that it can be held by an adult human hand while dispensing the foil tape onto a glass edge;
the tape roll core comprises an outside diameter of not more than substantially 1 inch; and
the tape roll comprises an outside diameter of not more than substantially 2.5-3.5 inches.

19. A glass foiling kit, comprising:
a set of plural visually encoded foil tape rolls, each foil tape roll comprising:
a tape roll core;
a quantity of flexible metallic foil tape wound around the tape roll core;
the foil tape having a length dimension, a width dimension that is substantially less than the length dimension, and a thickness dimension that is substantially less than the width dimension;
the foil tape comprising a metal foil layer, an adhesive layer on one side of the metal foil layer, and a peelable adhesive backing layer disposed on the adhesive layer;
the foil tape width dimension corresponding to an edge thickness of a glass edge onto which the foil tape is to be applied, and being sufficient such that the foil tape may cover the glass edge and wrap around adjacent side surfaces of the glass piece by a desired amount; and
the tape roll core displaying a non-alphanumeric visual encoding selected to identify the width dimension of the foil tape and distinguish the foil tape roll from the other foil tape rolls in the kit that comprise foil tape having different width dimensions and tape roll cores displaying different non-alphanumeric visual encodings selected to identify the different foil tape width dimensions.

20. The kit of claim 19, further comprising:
a handheld foil tape dispenser comprising a tape dispenser body sized to fit in one hand of an adult human and which can be selectively loaded with the plural foil tape rolls so that their foil tape can be dispensed onto a glass edge; and
a set of plural visually encoded foil tape dispensing tips each having a dispensing track whose width dimension matches the foil tape width dimension of a corresponding one of the plural foil tape rolls, and which can be selectively mounted on the tape dispenser body for use with the corresponding tape roll, the plural foil tape dispensing tips each displaying a non-alphanumeric visual encoding that matches the non-alphanumeric visual encoding displayed by the tape roll core of the corresponding foil tape roll and uniquely identifies the dispensing track width dimension of the foil tape dispensing tip as being compatible with the foil tape roll.

21. A glass foiling method, comprising:
accessing a glass foiling kit, the glass foiling kit comprising:
a set of plural visually encoded foil tape rolls, each foil tape roll comprising:
a tape roll core;
a quantity of flexible metallic foil tape wound around the tape roll core;
the foil tape having a length dimension, a width dimension that is substantially less than the length dimension, and a thickness dimension that is substantially less than the width dimension;
the foil tape comprising a metal foil layer, an adhesive layer on one side of the metal foil layer, and a peelable adhesive backing layer disposed on the adhesive layer;
the foil tape width dimension corresponding to an edge thickness of a glass edge onto which the foil tape is to be applied, and being sufficient such that the foil tape may cover the glass edge and wrap around adjacent side surfaces of the glass piece by a desired amount; and
the tape roll core displaying a non-alphanumeric visual encoding selected to identify the width dimension of the foil tape and distinguish the foil tape roll from the other foil tape rolls in the set that comprise foil tape having different width dimensions and tape roll cores displaying different non-alphanumeric visual encodings selected to identify the different foil tape width dimensions;
selecting a piece of glass whose edge is to be foiled, the glass edge having a characteristic edge thickness;
selecting one of the plural foil tape rolls based on the non-alphanumeric visual encoding displayed by its tape roll core that uniquely identifies the width dimension of the foil tape as corresponding to with the edge thickness of the selected piece of glass;
applying the foil tape of the selected foil tape roll onto the edge of the selected piece of glass by unwinding it from the foil tape roll.

22. The method of claim 21, wherein the glass foiling kit further comprises:
a handheld foil tape dispenser comprising a tape dispenser body sized to fit in one hand of an adult human user and which can be selectively loaded with the plural foil tape rolls so that their foil tape can be dispensed onto a glass edge; and
a set of plural visually encoded foil tape dispensing tips each having a dispensing track whose width dimension matches the foil tape width dimension of a corresponding one of the plural foil tape rolls, and which can be selectively mounted on the tape dispenser body for use with the corresponding tape roll, the plural foil tape dispensing tips each displaying a non-alphanumeric visual encoding that matches the non-alphanumeric visual encoding displayed by the tape roll core of the corresponding foil tape roll and uniquely identifies the dispensing track width dimension of the foil tape dispensing tip as being compatible with the foil tape roll;
and wherein the glass foiling method further comprises:
selecting one of the plural foil tape dispensing tips that displays a non-alphanumeric visual encoding corresponding to the non-alphanumeric visual encoding of the tape roll core of the selected foil tape roll;
mounting the selected foil tape dispensing tip on the tape dispenser body of the foil tape dispenser;
installing the selected foil tape roll in the foil tape dispenser; and
operating the foil tape dispenser to dispense the foil tape from the foil tape dispensing tip onto the edge of the selected piece of glass.
